(19) United States
(12) Patent Application Publication
(10) Pub. No.: US 2025/0141291 A1
(43) Pub. Date: May 1, 2025

(54) ELECTRIC MOTOR STATOR CONFIGURED FOR DIRECT CONDUCTOR COOLING WITHIN CONDUCTOR SLOTS OF STATOR

(71) Applicant: Garrett Transportation I Inc., Torrance, CA (US)

(72) Inventors: David Slama, Brno (CZ); Jakub Kadrnka, Brno (CZ); Filip Tomanec, Nivnice (CZ); Petr Chmelicek, Brno (CZ); Petr Kachlik, Telnice (CZ); Tsu-Ang Yang, Brno (CZ)

(73) Assignee: Garrett Transportation I Inc., Torrance, CA (US)

(21) Appl. No.: 18/498,100

(22) Filed: Oct. 31, 2023

(51) Int. Cl. H02K 3/24; H02K 3/12; H02K 15/02; H02K 15/06

(52) U.S. Cl. CPC H02K 3/24; H02K 3/12; H02K 15/021; H02K 15/062

(57) ABSTRACT

A stator for an electric motor includes a stator core defining slots within which electrical conductors are disposed. Coolant passages are defined within the slots by means of spacers that support the conductors, in such a manner that liquid coolant flowing in the coolant passages directly contacts the conductors. The spacers can define turbulence generators for causing the coolant to have turbulent flow to increase cooling effectiveness.

### BACKGROUND OF THE INVENTION

This application relates generally to electric motors, such as electric motors that power electric vehicles. The application more particularly relates to stator assemblies for such motors.

Electric motors of high efficiency are of increasing interest and importance in many industries, as governmental entities are encouraging manufacturers to move away from fossil fuel-powered technologies for vehicles and machinery, and toward electric-powered technologies. The automotive industry, for example, has set some ambitious timelines for switching over from gas- and diesel-powered cars and trucks, to electric vehicles of various architectures. The percentage of new sales of electric vehicles has sharply increased in recent years.

The continued success of the switch to electric vehicles will depend on many factors, with battery technology probably chief among them. In addition, however, improvement in electric motor technology is also likely to be a key aspect, because gains in electric motor efficiency translate into increased miles that can be driven on a full battery charge.

Moreover, as the switch to electric technology expands to larger and heavier vehicles, there will be a need for more and more powerful electric motors capable of delivering the necessary motive power.

Therefore, electric motor efficiency as well as cooling effectiveness are areas where development work is needed. Powerful electric motors generate substantial amounts of heat that must be effectively dissipated in order to prevent thermally induced degradation of the motor. The conductors within the stator portion of the motor are the primary source of such heat generation.

Numerous approaches to stator cooling have been developed or proposed. One common approach is to surround the stator with a sleeve known as a water jacket, and to flow coolant between the stator and the water jacket. In this case, cooling of the conductors relies on heat conduction through the stator core, which is an indirect way of cooling the heat generators. A variation on this technique is to form cooling channels within the stator core, which has the advantage of getting the coolant closer to the conductors, but still depends on conduction through the stator core.

While direct coolant-conductor contact has been recognized as substantially more-effective, some proposals for implementing this idea have left much to be desired. For instance, DE 10 2017 213 662A1 assigned to Audi AG proposes containing the electrical conductors within an elaborate groove cooler structure, with one such groove cooler for each stator slot. The conductors are supported only at their edges, via projections from the surrounding groove cooler. The substantial complexity and expense of the groove cooler arrangement likely would prevent widespread adoption of this technology.

There is thus a need for further improvement in stator cooling for electric motors.

### SUMMARY OF THE DISCLOSURE

The present disclosure describes stator technology that achieves direct coolant-conductor contact in a manner that should be comparatively simple to implement, at scale, within acceptable cost constraints. In accordance with one embodiment of the present invention, a stator for an electric motor comprises:
a stator core defining a plurality of slots circumferentially spaced about a circumference of the stator core; and
a plurality of conductor assemblies respectively disposed within the plurality of slots, each conductor assembly extending lengthwise along the respective slot and comprising:
   a first conductor, a member, and a first spacer disposed between the first conductor and the member such that the first spacer supports and spaces the first conductor from the member, the first spacer being spaced from circumferentially opposite walls of the slot such that a first coolant passage is defined between the first spacer and one of said walls and a second coolant passage is defined between the first spacer and another of said walls for receiving a flow of liquid coolant therethrough, lengthwise along the slot, the first coolant passage and the second coolant passage being bounded radially by the first conductor such that coolant makes direct contact with a face of the first conductor.

The first spacer is positioned to support the first conductor at or near its midpoint as opposed to its outer edges, thus facilitating stable support of the conductor. The two coolant passages provide direct coolant-conductor contact for highly effective heat transfer from the conductor.

In some embodiments, heat transfer effectiveness can be further enhanced by turbulence generation within the coolant flow. In accordance with such embodiments, the first spacer can define turbulence generators axially spaced along the coolant passages.

Multiple conductors within a stator slot can be accommodated by employing a plurality of such spacers so that each conductor receives direct coolant-conductor contact.

The present disclosure also relates to a method of making a stator assembly having such spacer-defined coolant passages.

### BRIEF DESCRIPTION OF THE DRAWINGS

Having described the present disclosure in general terms, reference will now be made to the accompanying drawing(s), which are not necessarily drawn to scale, and wherein:

FIG. 1 is an isometric view of a stator that does not embody the present invention;

FIG. 2 is an axial end view of the stator of FIG. 1;

FIG. 2A is a detail view of a portion of the stator of FIG. 2;

FIG. 3 is an exploded view of a stator in accordance with one embodiment of the invention, showing one “pie wedge” of the stator comprising a single slot, with three conductors and two spacers;

FIG. 3A is a conceptual isometric view of a partial conductor assembly comprising two conductor and two spacers in accordance with another embodiment of the invention;

FIG. 4 is an isometric view of the stator “pie wedge” of FIG. 3 in an assembled state, with the conductor assembly contained within the stator slot;

FIG. 5 is a top view of the stator of FIG. 4, after sectioning on a plane designated 5-5 in FIG. 6, parallel to the juncture between the topmost conductor and the adjacent spacer;

FIG. 6 is a front (axial end) view of the stator of FIG. 4;

FIG. 7 is an isometric view of the sectioned stator of FIG. 5;

FIG. 8 is an isometric view of a spacer in accordance with one embodiment;

FIG. 8A shows the cross-sectional shape of the spacer of FIG. 8;

FIG. 9 is an isometric view of a spacer in accordance with another embodiment;

FIG. 10 is an isometric view of a spacer assembly that can be used in a method of making a stator in accordance with a further embodiment of the invention; and

FIGS. 11A-11D illustrate a method of making a stator in accordance with one embodiment of the invention.

### DETAILED DESCRIPTION OF THE DRAWINGS

The present disclosure will now be described in fuller detail with reference to the above-described drawings, which depict some but not all embodiments of the invention(s) to which the present disclosure pertains. These inventions may be embodied in various forms, including forms not expressly described herein, and should not be construed as limited to the particular exemplary embodiments described herein. In the following description, like numbers refer to like elements throughout.

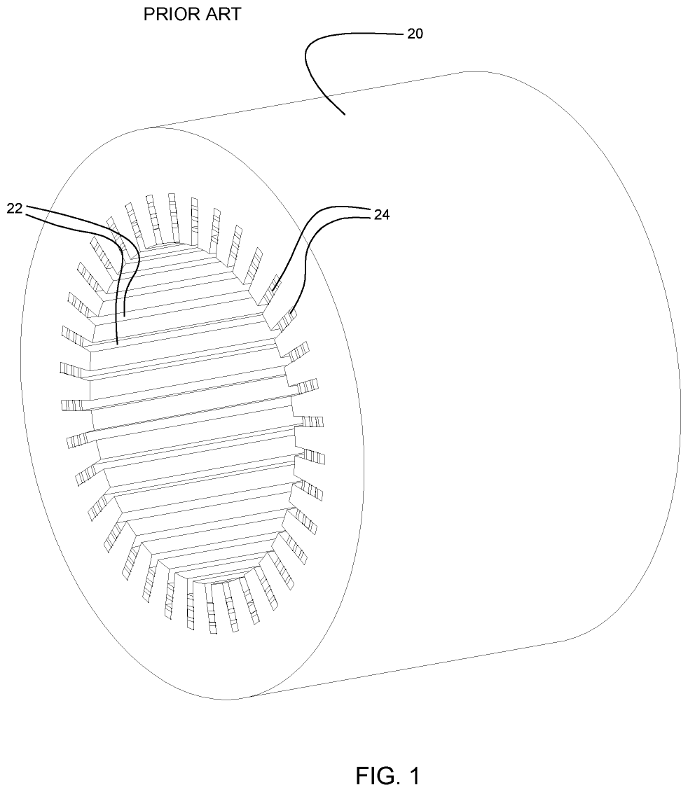

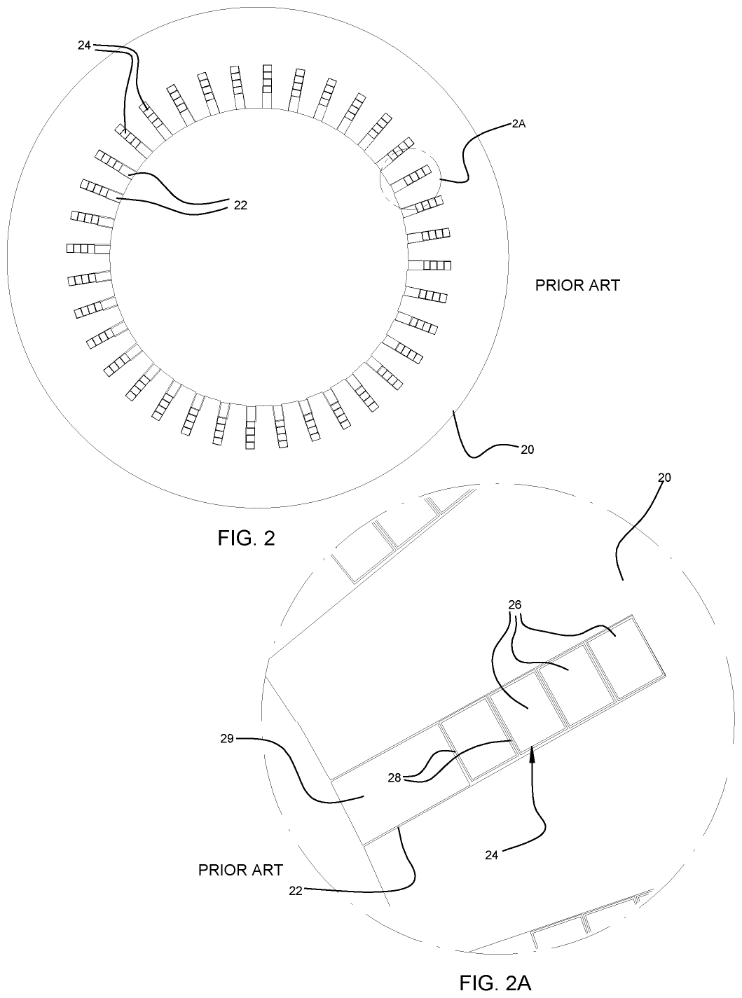

FIGS. 1 through 2A illustrate an example of a stator that does not embody the present invention. The stator is of the type having conductors commonly called hairpin conductors because of the narrow U-shaped configuration of the conductors, which are typically of rectangular cross-section. The stator core 20 comprises a hollow (typically cylindrical) body composed of an iron-based material. Stator cores are usually constructed as laminated steel structures, and they include slots 22 arranged in a radial array, circumferentially spaced about the center axis of the core. As shown, the slots can be located at the inner circumference of the core, open at their radially inner ends to facilitate assembly of the core with the electrical conductors for the motor stator. Each slot contains a conductor assembly 24. As best seen in FIG. 2A, each conductor assembly 24 comprises one or more electrical conductors 26 that extend axially along the stator slot. The arrangement shown in FIG. 2A includes three conductors 26 that are disposed in a stack and are electrically insulated from one another by suitable insulating material 28 that coats all faces of the conductors. Various suitable insulating materials for this purpose are known (e.g. NOMEX® available from Dupont de Nemours, Inc.). Once all the conductor assemblies 24 are properly located in their respective slots 22, radial sealing of the slots is accomplished, for example by inserting sealing wedges 29 into the slots. The entire stator assembly is then immersed in an epoxy resin bath and the resin is hardened to bond all parts together and electrically insulate it.

As previously noted, effective cooling of a stator is important to prevent excessive motor temperatures that can degrade the life of the motor. Cooling schemes that rely on heat conduction through the stator core are not as effective as desired, and some can entail significant added expense for components such as sleeves and groove coolers.

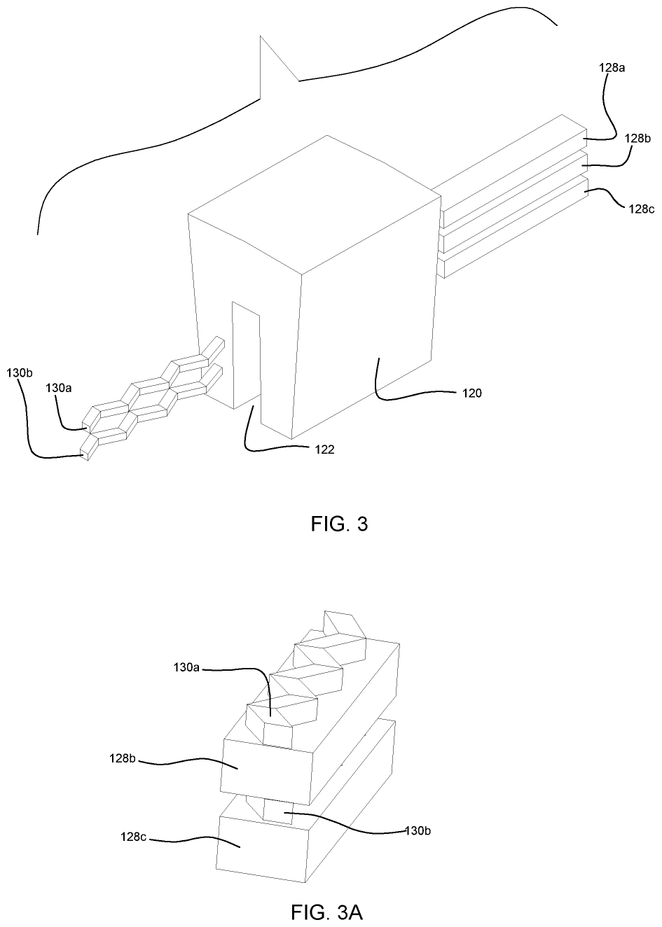

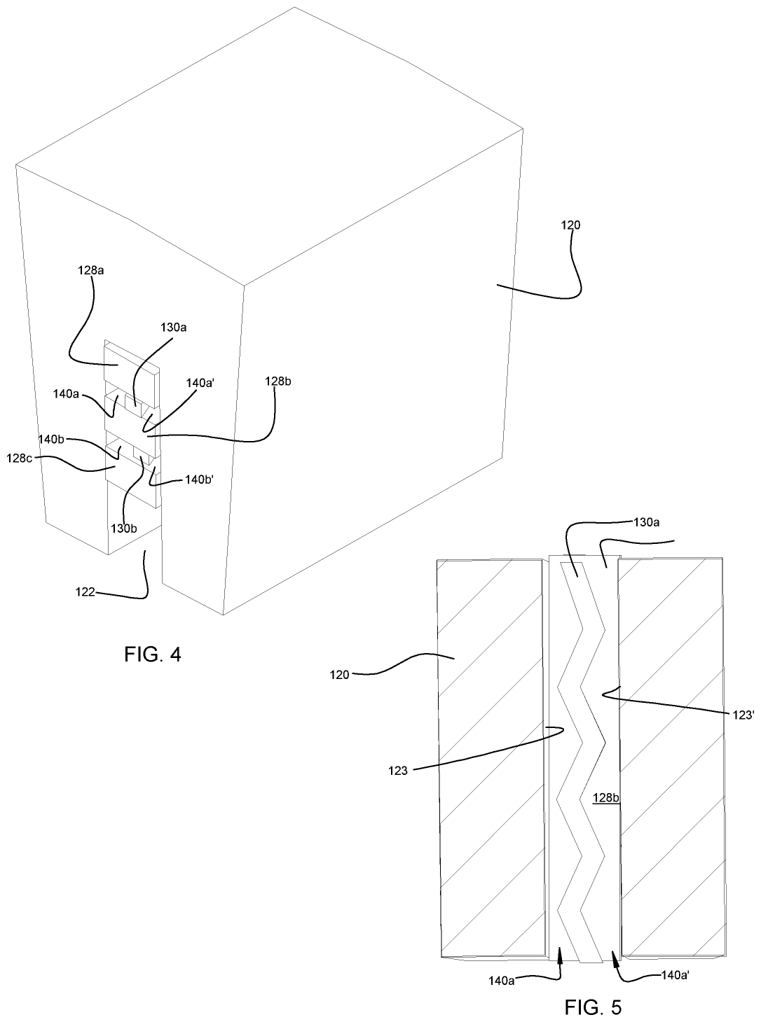

The present invention provides a stator construction able to achieve highly effective cooling at a cost level that makes it more attractive than some of the complex and costly schemes of the prior art. With reference to FIG. 3, a single “pie wedge” section of a stator in accordance with an embodiment of the invention, comprising a single slot and associated conductor assembly components, is shown. The stator comprises a stator core 120 defining a slot 122 for receipt of the conductor assembly components. In the illustrated embodiment, the conductor assembly comprises three conductors 128a, 128b, and 128c, and two spacers 130a and 130b. The conductors are arranged in a radial stack with the spacers disposed between radially adjacent conductors, as best seen in FIG. 4. Radial sealing of the slots can be accomplished in any of various ways, including but not limited to using the innermost conductor 128c as the radial sealing device, providing the stator core itself as a closed-slot design, or inserting sealing wedges (similar to sealing wedges 29 previously described in connection with FIG. 2A). It will be understood that the drawings depict only the portions of the conductors within the slots, the portions projecting out from the slots having been removed for clarity of illustration. The conductors comprise copper conductors or the like, and can have a rectangular cross-section as shown, or can have any of various cross-sectional shapes. In the case of rectangular conductors, the conductor widths substantially fully fill the circumferential width of the slot 122 between its opposite walls 123 and 123′ (FIG. 5). The spacers 130a,b comprise a material that is non-magnetic and electrically insulating, non-limiting examples of which include engineered plastics, composites composed of carbon or glass fibers with resins, ceramics, and the like.

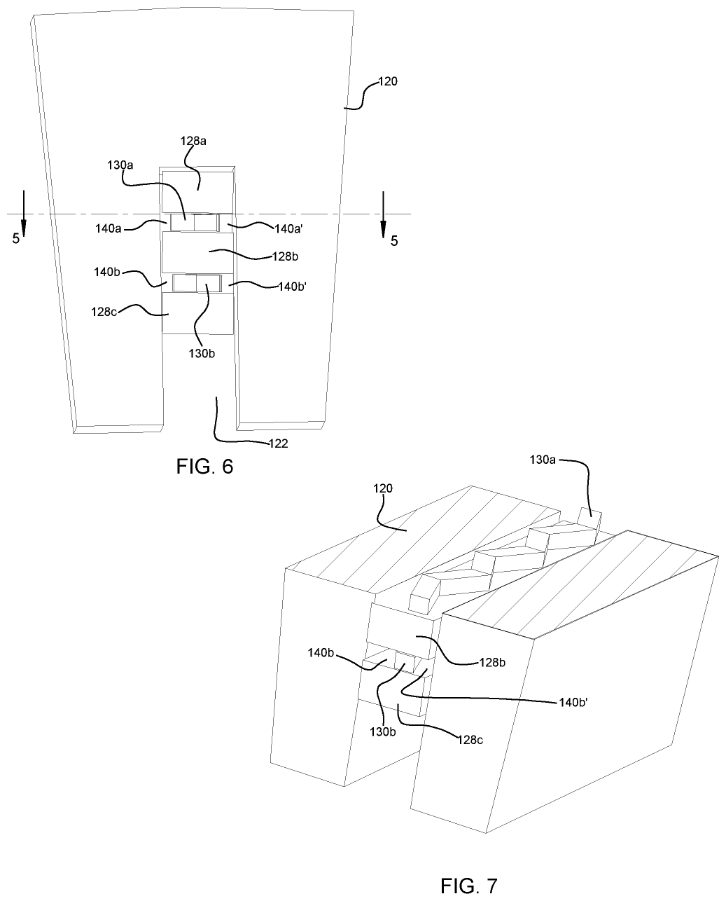

In accordance with the invention, the spacers serve multiple functions: supporting and stabilizing the conductors by abutting contact with the conductors; bounding and helping to define coolant passages through the stator; and (in some embodiments) generating turbulence in the coolant flows along the coolant passages. The coolant passages are defined by virtue of the spacers being formed as elongate wires (linear or non-linear in shape) whose width in the circumferential direction is substantially smaller than the circumferential width of the stator slots, and by virtue of the spacers being centrally disposed within the slots so as to support the conductors at or near their circumferential midpoint. As illustrated in FIGS. 4-7, the result is that each spacer plays a role in defining two coolant passages, one on either circumferential side of the spacer. Thus, the spacer 130a cooperates with the conductors 128a and 128b and the opposite slot walls 123 and 123′ (FIG. 5) to define a first coolant passage 140a on one side of the spacer and a second coolant passage 140a′ on the other side. Similarly, the spacer 130b cooperates with the conductors 128b and 128c and the opposite slot walls to define a third coolant passage 140b and a fourth coolant passage 140b′. In use of the stator, a liquid coolant is circulated through these coolant passages to cool the conductors. The invention has the advantage of providing direct coolant-conductor contact for highly effective cooling of the conductors.

It will be understood that the invention is not limited to any particular number of conductors and spacers. A stator in accordance with the invention can have a single conductor and a single spacer per slot, or a plurality of conductors and spacers of whatever number per slot is desired in a given application. In general, a spacer in accordance with the invention will be located between a conductor and a member to space the conductor from the member and to form coolant passages bounded radially between the conductor and the member, and bounded circumferentially between the slot walls. The member can be a further conductor as in the illustrated embodiment of FIGS. 3-7, or it can be another structure such as the end wall of the stator slot, or a sealing wedge.

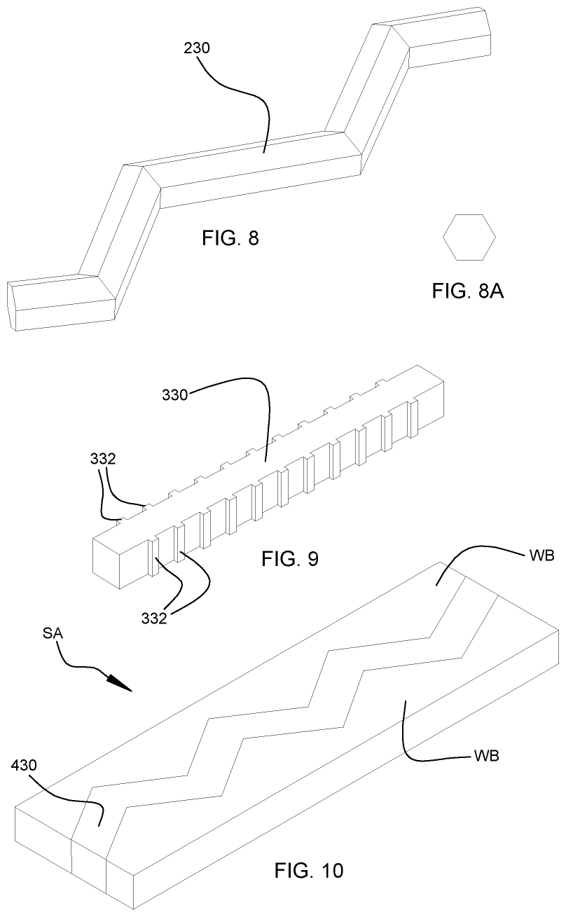

The spacers in accordance with the invention can have any of various plan shapes (linear or non-linear) and cross-sectional shapes (including but not limited to square, rectangular, hexagonal, circular, oval). As noted, in some embodiments, the spacers can generate turbulence in the coolant flows. To this end, in some embodiments the spacers define a plurality of turbulence generators spaced along the length of the spacers. The turbulence generators can take any of various forms. One type of turbulence generator comprises undulations of the spacers as shown for example for spacers 130a and 130b in FIGS. 3 and 5. A further example of an undulating spacer 230 is shown in FIGS. 8 and 8A, having a zigzag plane shape similar to the spacers 130a,b but having a hexagonal cross-section. An undulating spacer can have various plan shapes such as zigzag (triangular wave form), a sine-type wave form, a square wave form, or the like. Whatever form the undulations take, they give rise to localized flow separations that are turbulent. The turbulence of the coolant flow results in a higher heat-transfer rate between the conductors and the coolant.

FIG. 9 illustrates another embodiment of a spacer 330 having turbulence generators of a different type. The spacer 330 has a linear plan shape and a rectangular cross-section. Protruding from each of the opposite sides of the spacer are a plurality of projections 332 spaced along the length of the spacer. The projections are illustrated as ridges that extend in the thickness (radial) direction of the spacer, but projections of other configurations can be used, including but not limited to discrete bumps or nubs arranged in an array along each side face of the spacer. Alternatively, the side faces of the spacer can have a large-scale roughness such as a raised grid or mesh configuration. Other types of turbulence generators can also be used in the practice of some embodiments of the invention.

The present invention also relates to methods of making a stator. In one embodiment, a method of making a stator assembly for an electric motor comprises the steps of:
providing a stator core defining a slot extending axially along the stator core;
inserting a conductor into the slot, the conductor extending axially along the slot;
inserting a spacer assembly into the slot adjacent the conductor, the spacer assembly comprising a spacer and a wax body joined to the spacer;
inserting a member into the slot to capture the spacer assembly between the conductor and the member; and
heating the stator assembly to melt the wax body out of the stator assembly so as to form a coolant passage comprising a space previously occupied by the wax body.

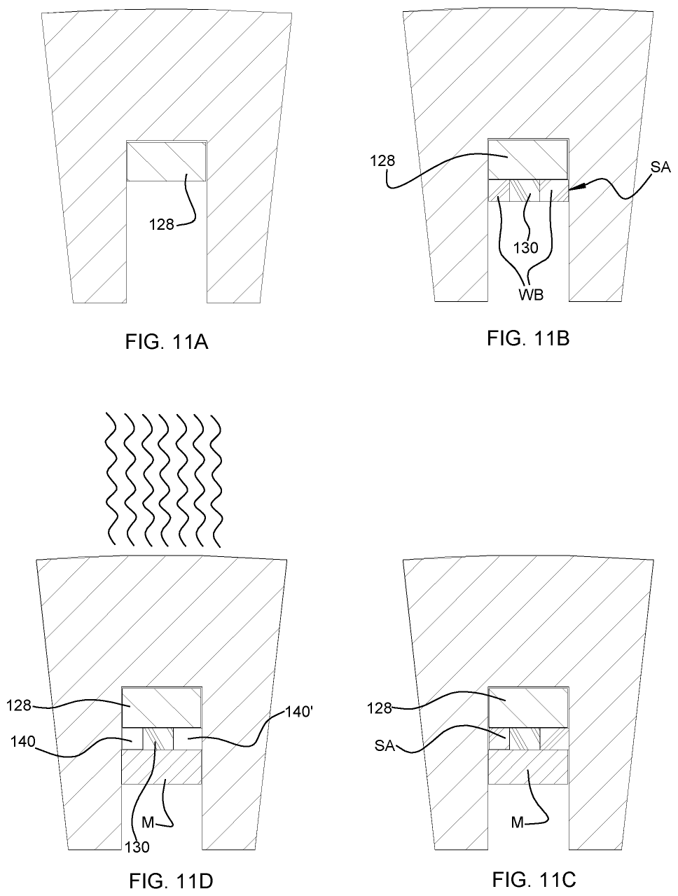

FIG. 10 illustrates one embodiment of a spacer assembly SA for use in such a method. FIG. 11 is a sequence of views of a stator section at various stages of such a method. Thus, in FIG. 11A, a conductor 128 is inserted into the stator slot. Next, as shown in FIG. 11B, a spacer assembly SA (comprising spacer 130 and wax body WB) is inserted into the slot against the conductor. Following that, as shown in FIG. 11C, a member M is inserted into the slot against the spacer assembly. Finally, in FIG. 11D, the assembly is heated as denoted by the wavy lines (e.g., by immersion in a hot oil bath), to melt out the wax body WB of the spacer assembly. As a result, cooling passages 140 and 140′ are formed where the wax formerly existed.

As previously noted, once the conductor assemblies are in place within the slots of the stator core, the entire assembly is resin-treated to bond all parts together. Typically a steel sleeve is first inserted into the ID of the core to close the open ends of the slots, followed by the resin treatment. The invention, however, is not limited with respect to such additional assembly steps.

Based on the description of the embodiments of the invention herein, it will be appreciated that the invention can facilitate direct conductor-coolant contact in a relatively simple fashion. No costly water jacket or elaborate groove cooler structures are needed, thereby reducing mass and expense, and assembly can readily be carried out. The invention accommodates rectangular cross-section conductors, which are industry standard and cost-efficient. The invention provides coolant passages without impact on stator core lamination in the teeth area. Accordingly, the invention can lead to increased motor efficiency and decreased motor mass.

Persons skilled in the art, on the basis of the present disclosure, will recognize that modifications and other embodiments of the inventions described herein can be made without departing from the inventive concepts described herein. Specific terms used herein are employed for explanatory purposes rather than purposes of limitation. Accordingly, the inventions are not to be limited to the specific embodiments disclosed, and modifications and other embodiments are intended to be included within the scope of the appended claims.

What is claimed is:

1. A stator for an electric motor, comprising:
a stator core defining a plurality of slots circumferentially spaced about a circumference of the stator core;
a plurality of conductor assemblies respectively disposed within the plurality of slots, each conductor assembly extending lengthwise along the respective slot and comprising:
a first conductor, a member, and a first spacer disposed between the first conductor and the member such that the first spacer supports and spaces the first conductor from the member, the first spacer being spaced from circumferentially opposite walls of the slot such that a first coolant passage is defined between the first spacer and one of said walls and a second coolant passage is defined between the first spacer and another of said walls for receiving a flow of liquid coolant therethrough, lengthwise along the slot, the first coolant passage and the second coolant passage being bounded radially by the first conductor such that coolant makes direct contact with a face of the first conductor.

2. The stator of claim 1, wherein each of the first spacers defines turbulence generators for generating turbulence in the flow of liquid coolant.

3. The stator of claim 2, wherein each of the first spacers includes axially spaced undulations, the undulations comprising said turbulence generators.

4. The stator of claim 2, wherein the turbulence generators comprise projections extending from circumferentially opposite sides of each of the first spacers.

5. The stator of 4, wherein each of the first spacers extends linearly along the slot.

6. The stator of claim 1, wherein the member of each conductor assembly comprises a second conductor and each conductor assembly further comprises a second member and a second spacer disposed between the second conductor and the second member such that the second spacer supports and spaces the second conductor from the second member, the second spacer being spaced from said walls of the slot such that a third coolant passage is defined between the second spacer and one of said walls and a fourth coolant passage is defined between the second spacer and another of said walls for receiving a flow of liquid coolant therethrough, lengthwise along the slot, the third coolant passage and the fourth coolant passage being bounded radially by the second conductor such that coolant makes direct contact with a face of the second conductor.

7. A stator for an electric motor, comprising:
a stator core defining a plurality of slots circumferentially spaced about a circumference of the stator core;
a conductor extending lengthwise along each slot;
a coolant passage extending lengthwise along each slot, the coolant passage being bounded on one side by a face of the conductor, and a plurality of turbulence generators spaced along the coolant passage such that a flow of liquid coolant encounters the turbulence generators within the slot.

8. The stator of claim 7, wherein each slot contains a spacer that supports the conductor, and wherein the turbulence generators are defined by the spacers.

9. The stator of claim 8, wherein the turbulence generators comprise undulations of the spacers.

10. The stator of claim 8, wherein the turbulence generators comprise projections formed on the spacers.

11. A method of making a stator assembly for an electric motor, comprising the steps of:
providing a stator core defining a slot;
inserting a conductor into the slot, the conductor extending lengthwise along the slot;
inserting a spacer assembly into the slot adjacent the conductor, the spacer assembly comprising a spacer and a wax body joined to the spacer;
inserting a member into the slot to capture the spacer assembly between the conductor and the member; and
heating the stator assembly to melt the wax body out of the stator assembly so as to form a coolant passage comprising a space previously occupied by the wax body.

12. The method of making a stator assembly of claim 11, wherein the spacer is disposed centrally of the wax body of the spacer assembly such that the spacer is spaced from circumferentially opposite walls of the slot, resulting in a first coolant passage being defined between the spacer and one of said walls and a second coolant passage being defined between the spacer and another of said walls.

13. The method of making a stator assembly of claim 12, wherein the spacer is provided to have an undulating shape.

14. The method of making a stator assembly of claim 12, wherein the spacer is provided to have axially spaced projections.
